(19) United States
(12) Patent Application Publication
(10) Pub. No.: US 2021/0103382 A1
(43) Pub. Date: Apr. 8, 2021

(54) DYNAMIC TIMELINE DISPLAY

(71) Applicant: LOOKIIMEDIA (UK) LIMITED, London (GB)

(72) Inventor: Julia O'TOOLE, London (GB)

(21) Appl. No.: 16/472,276

(22) PCT Filed: Dec. 22, 2017
(86) PCT No.: PCT/GB2017/000183

§ 371 Date: Jun. 21, 2019

(30) Foreign Application Priority Data
Dec. 22, 2016 (GB) 1621971.9

(51) Int. Cl. G06F 3/0484; G06Q 10/10; G06F 3/14; G06F 3/0483

(52) U.S. Cl. CPC G06F 3/04847; G06F 3/0483; G06F 3/1431; G06Q 10/109

(57) ABSTRACT

The present invention relates to a method of providing a timeline display with a first dynamically sized display area and a second dynamically sized display area. The timeline display is displayed with a timeline scroll axis and a category axis, the first dynamically sized display area is displayed in the timeline display with a first length parallel to the category; axis, the first dynamically sized display area associated with a first category associated with one or more first category events, the first length being proportionate to a first user-directed variable, and the second dynamically sized display area is displayed in the timeline display with a second length parallel to the category axis, the second dynamically sized display area associated with a second category including one or more second category events, the second length being proportionate to a second user-directed variable.

### FIELD OF INVENTION

The present invention is in the field of interactive displays. More particularly, but not exclusively, the present invention relates to a dynamic timeline display.

### BACKGROUND

The amount of information, both digital and otherwise, that the average user manages is ever increasing. Many users interact with information from multiple sources, including, but not limited to: calendars, news agencies, social media, task managers, project software, and email.

There are various productivity applications in the art that help users integrate, track, categorize, and filter information. Some productivity applications allow users to merge information from other applications. For example, Google App can display calendar information, local weather, flight status, and news relating to a user's interests, some of which may be learned from other Google products, such as Google calendar entries, Gmail correspondence, or Google maps searches.

Consumers are relying increasingly on their smart phones and tablet devices to access their data, however, trending away from laptop and desktop computers. As the market moves towards the use of smaller screens, the space to display data becomes highly constrained. Navigating a large amount of information can be a challenge on the 2.5 by 5.5 inch screen provided by an iPhone 5, for example.

While some productivity applications may allow users to manually sort or prioritize items using lists, prior methods require users to identify desired data by scrolling through long collections of data, or through work spaces that include vastly more information than can be displayed and easily understood on a small screen. This may not make the best use of space on a smart phone, and the experience of visually jumping between data can cause confusion and sensory overload the user. The user may not be able to locate important data quickly or efficiently.

It is an object of the present invention to provide a method of display that overcomes the disadvantages of the prior art, or at least provides a useful alternative.

### SUMMARY OF INVENTION

According to a first aspect of the invention there is provided a method for providing a timeline display with a first dynamically sized display area and a second dynamically sized display area. The method comprises:

providing for displaying the timeline display with a timeline scroll axis and a category axis;

providing for displaying the first dynamically sized display area in the timeline display with a first length parallel to the category axis, the first dynamically sized display area associated with a first category associated with one or more first category events, the first length being proportionate to a first user-directed variable; and

providing for displaying the second dynamically sized display area in the timeline display with a second length parallel to the category axis, the second dynamically sized display area associated with a second category including one or more second category events, the second length being proportionate to a second user-directed variable.

According to a further aspect, the first user-directed variable may be a number of first category events and the second user-directed variable is a number of second category events.

According to a further aspect, the first user-directed variable may be a number of first category displayed events and the second user-directed variable is a number of second category displayed events.

According to a further aspect, the first user-directed variable may be a first user-designated importance level and the second user-directed variable may be a second user-designated importance level.

According to a further aspect, the method may further comprise:

providing for displaying a category display selection user interface.

According to a further aspect, the method may further comprise:

providing for transmitting a category display selection to a server.

According to a further aspect, each respective first category event of the one or more first category events and each respective second category event of the one or more second category events may be associated with a respective data item.

According to a further aspect, at least one of the first category or the second category may be associated with a respective data item.

According to a further aspect, each respective data item may be associated with at least one of: text, photo, video, audio, a document, a website, or a link.

According to a further aspect, at least one of the first category or the second category may further include one or more attributes, including at least one of: a tag, a to do, a comment, a geographical location, a submitter, a creation time, a creation date, a rating, a number of views, an associated data entry, changes to the data entry, file size, a link, a topic of conversation, a price, an associated group, a price, a file, a permissions parameter, or a vote parameter. Other attributes are also possible, as will be understood by those of skill.

According to a further aspect, at least one of a first category event or a second category event may further include at least one of: a tag, a to do, a comment, a geographical location, a submitter, a creation time, a creation date, a rating, a number of views, an associated data entry, changes to the data entry, file size, a link, a topic of conversation, a price, an associated group, a price, a file, a permissions parameter, or a vote parameter.

According to a further aspect, the method may further comprise:

providing for displaying an event preview window upon determining that a cursor is within a preview trigger area of the displayed event in the timeline display.

According to a further aspect, the method may further comprise:

providing for displaying an event information window upon determining that a user has selected the displayed event.

According to a further aspect, the method may further comprise:

providing for displaying a first icon in the first dynamically sized display area and a second icon in the second dynamically sized display area.

According to a further aspect, a first icon length may be proportionate to the first length and a second icon length may be proportionate to the second length.

According to a further aspect, the method may further comprise:

providing for displaying a displayed event title in the timeline display.

According to a further aspect, the method may further comprise:

providing for displaying a displayed event icon in the timeline display.

According to a further aspect, the first category may be associated with a first data item including text, and the first icon may include at least a subset of miniaturized text from the first data item.

According to a further aspect, the timeline display may include a second scrollable axis along the category axis.

According to a further aspect, the method may further comprise:

upon receiving a request to minimize the first dynamically sized display area, providing for reducing the first dynamically sized display area.

According to a further aspect, the timeline display may further include a timescale adjustment for the timeline scrollable axis.

According to a further aspect, the at least a first event of the one or more first category events may be displayed in a first colour for a first urgency value, and at least a second event of the one or more first category events may be displayed in a second colour for a second urgency value.

According to a further aspect, the at least a first event of the one or more first category events may be displayed at a first blink rate for a first urgency value, and at least a second event of the one or more first category events may be displayed in a second blink rate for a second urgency value.

According to a further aspect, the at least a first event of the one or more first category events may be displayed with a first icon for a first urgency value, and at least a second event of the one or more first category events may be displayed with a second icon for a second urgency value.

According to a further aspect, the method may further comprise:

providing for displaying a new event creation user interface;

providing for receiving a new event from the new event creation user interface; and

providing for sending the new event to a server.

According to a further aspect, the method may further comprise:

providing for displaying a new category creation user interface;

providing for receiving a new category from the new category creation user interface; and

providing for sending the new category to a server.

According to a further aspect, the method may further comprise:

providing for displaying a search user interface;

receiving an event selection; and

displaying an updated timeline display.

According to a further aspect, there may be a system configured to provide an interactive timeline display via the method of the first aspect.

According to a further aspect, there may be a computer program configured to provide an interactive timeline display via the method of any one of the first aspect.

According to a further aspect, there may be an electronically readable medium configured for storing the computer program of the first aspect.

According to a further aspect, there may be a method and system as herein described with reference to the Figures.

Other aspects of the invention are described within the claims.

### BRIEF DESCRIPTION OF THE DRAWINGS

Embodiments of the invention will now be described, by way of example only, with reference to the accompanying drawings in which:

FIG. 1: depicts system 100 in accordance with an embodiment of the invention;

FIG. 2: depicts system 200 in accordance with an embodiment of the invention;

FIG. 3: depicts system 300 in accordance with an embodiment of the invention;

FIG. 4: depicts method 400 in accordance with an embodiment of the invention;

FIG. 5: depicts method 100 in accordance with an embodiment of the invention;

20

FIG. 6: depicts method 100 in accordance with an embodiment of the invention;

FIG. 7: depicts timeline display 700 in accordance with an embodiment of the invention;

FIG. 8: depicts timeline display 800 in accordance with an embodiment of the invention;

FIG. 9: depicts user interface 900 in accordance with an embodiment of the invention;

FIG. 10: depicts user interface 1000 in accordance with an embodiment of the invention;

FIG. 11: depicts user interface 1100 in accordance with an embodiment of the invention;

FIG. 12: depicts user interface 1200 in accordance with an embodiment of the invention;

FIG. 13A: depicts user interface 1300 in accordance with an embodiment of the invention;

FIG. 13B: depicts user interface 1350 in accordance with an embodiment of the invention; and

FIG. 14: depicts sequence diagram 1400.

### DETAILED DESCRIPTION OF PREFERRED EMBODIMENTS

The present invention provides a method, system, and computer program for providing a timeline display with a first dynamically sized display area and a second dynamically sized display area.

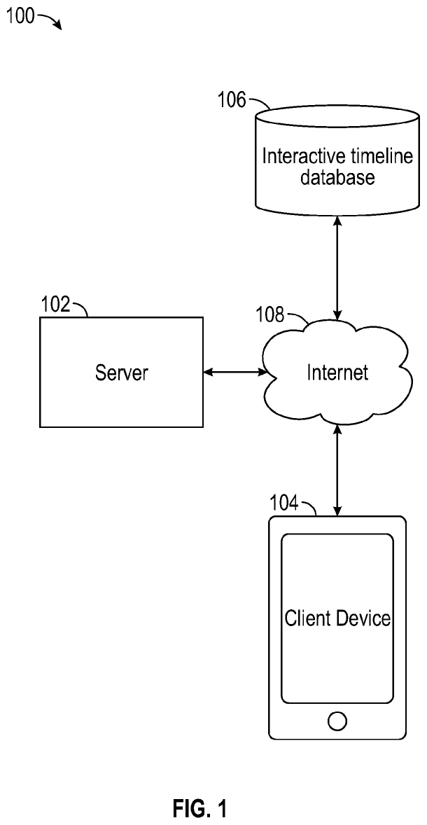

FIG. 1 depicts a system 100 in accordance with an embodiment. System 100 includes server 102 and client device 104. System 100 may further include interactive timeline database 106 and Internet 108.

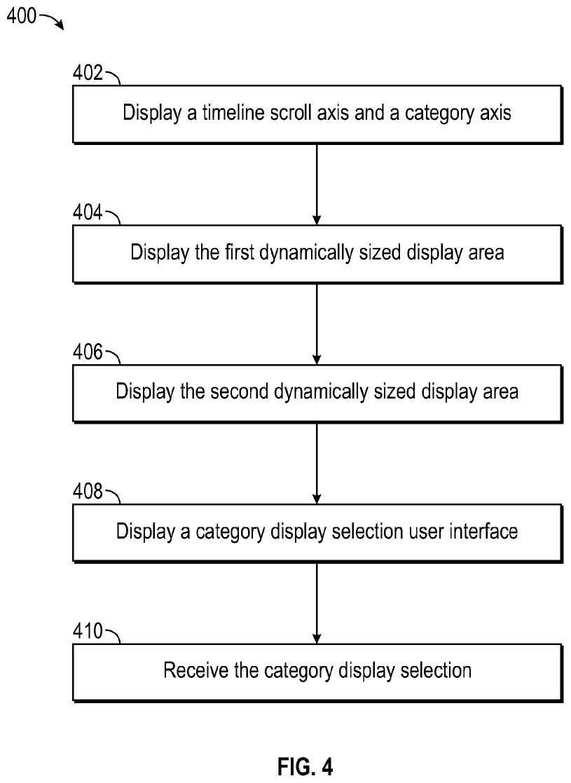

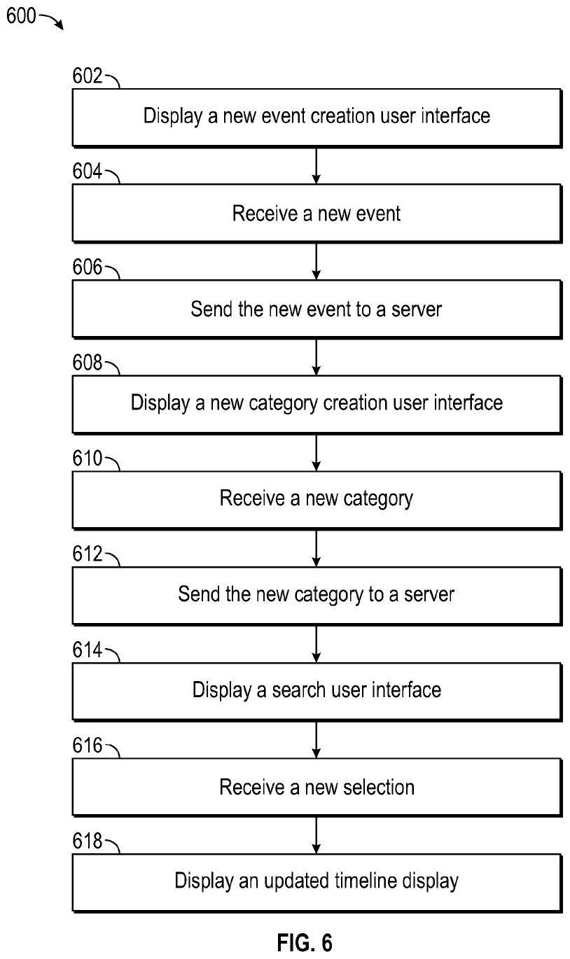

Server 102 may be operable to facilitate saving and retrieving information from interactive timeline database 106, and receiving and providing information to client device 104. Client device 104 may be operable to provide a timeline display, as described in relation to FIGS. 4 to 13.

FIG. 1 includes a server 102. Server 102 may be operable to execute instructions, or to retrieve and save data in a database. In examples, server 102 may include a single server, or multiple servers in a distributed architecture. In examples, server 102 may support a relational database, a NoSQL database, a distributed database, or any other database known to those of skill.

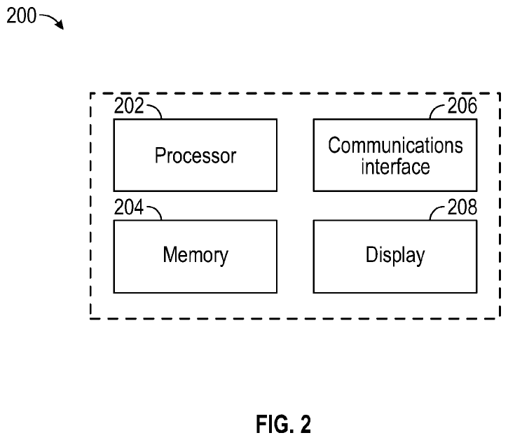

Client device 104 may include a processing device 200, as depicted in FIG. 2. Processing device 200 includes a processor 202, a memory 204, a communication interface 206, and a display 208.

Processor 202 may be configured for executing computer instructions, which, when executed on the system 100, perform a portion or all of the methods described in relation to FIGS. 4 to 13. In embodiments, processor 202 may include a single, or any multiple number of processors, as will be understood by those of skill in the art.

Memory 204 may be an electronically readable medium or a computer readable medium configured to store computer program instructions. In examples, memory 204 may include a non-transitory medium.

Stored computer program instructions, when executed on the processor 202, may perform a portion or all of the methods described in relation to FIGS. 4 to 13.

In examples, processor 202 and memory 204 may be incorporated into a custom chipset, such as a system on a chip or a field-programmable gate array (FPGA). For example, processor 202 and memory 204 may be incorporated into a custom Snapdragon, Tegra, Mali-400, Cortex, Samsung Exynos, Intel Atom, Apple, or Motorola chip, or any other type of chip known to those of skill in the art.

In examples, portions of the methods described in relation to FIGS. 4 to 13 may be stored or executed outside of system 100. For example, a portion of the methods described in relation to FIGS. 4 to 13 may be stored or executed on a combination of a server and cloud storage facility via Internet 108.

Communications interface 206 may be configured to communicate with devices external to server 102 or client device 104. For example, communications interface 206 may communicate with interactive timeline database 106.

In examples, communications interface 206 may include wired or wireless interfaces. Communications interface 206 may include a short-range or low-powered wireless standard such as Bluetooth, Bluetooth LE, zigbee, or near field communication (NFC). Communications interface 206 may further include WIFI, 3G, 4G, Ethernet, or any other communications known to those of skill in the art. In examples, processing device 200 may request, send, or receive information, save information, or send or receive messages from a remote device over Internet 108.

In examples, client device 104 may be a hand-held or mobile computing device such as a smart phone, a tablet, a smart watch, or a wearable device. In further examples, client device 104 may be a computing apparatus such as a smart TV, a video game console, a laptop, or desktop computer, or an app-enabled piece of household hardware.

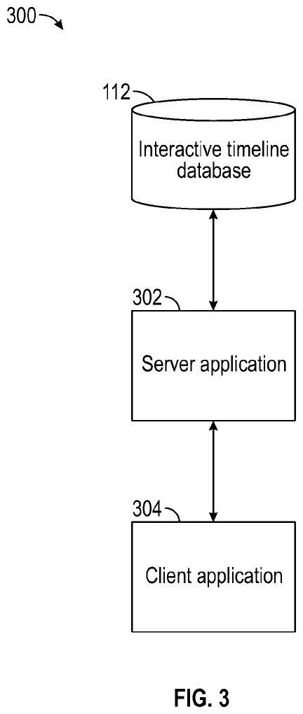

FIG. 3 depicts system 300, in accordance with an embodiment. System 300 may facilitate providing a timeline display with a first dynamically sized display area and a second dynamically sized display area. System 300 includes server application 302 and client application 304. System 300 may further include interactive timeline database 112.

In examples, server application 302 and client application 304 may each operate on separate devices. For example, server application 302 may operate on server 102 and client application 304 may operate on client device 104. In further examples, however, the functions of server application 302 and client application 304 may be distributed across additional computing devices. For example, server application 302 may operate across a group of distributed servers.

FIG. 4 depicts method 400, an example embodiment that may provide a method that executes within client application 304. Alternatively, method 400 may provide a method for configuring client application 304 to execute the steps included within the method. Method 400 may provide for generating a timeline display with a first dynamically sized display area and a second dynamically sized display area.

A timeline display provides a display of one or more events along a timeline. In examples, the events displayed in the timeline display may be related to one or more planned events, data items, reminders, or any other item that may be associated with a date.

A dynamically sized display area may include an area of a display window or display user interface that may be dynamically sized or resized according to one or more criteria.

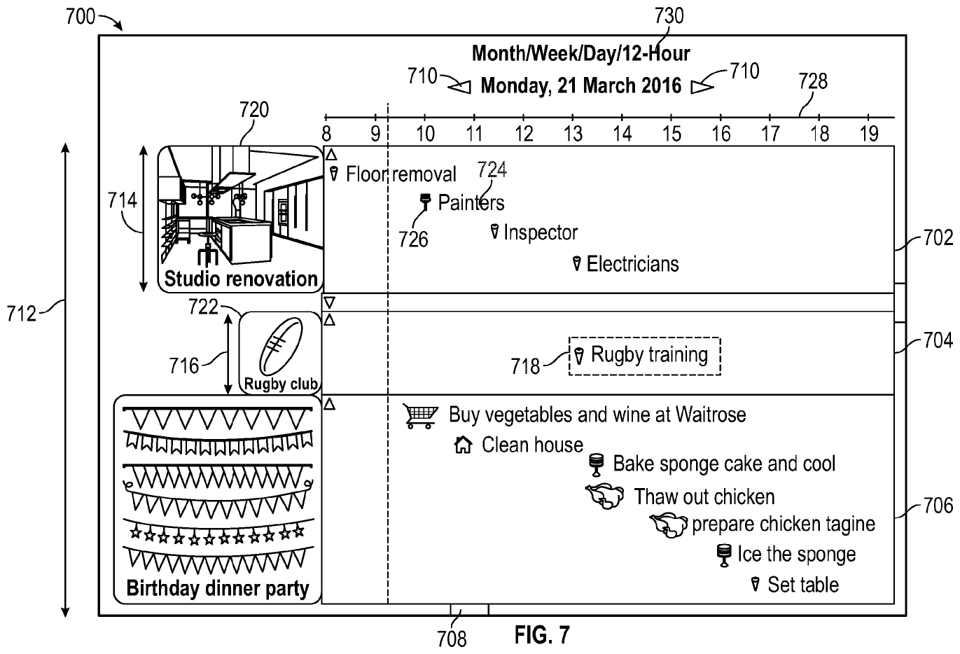

FIG. 7 depicts example timeline display 700. Example timeline display 700 includes a first dynamically sized display area 702, a second dynamically sized display area 704, and a third dynamically sized display area 706. Each of example first, second, and third dynamically sized display areas 702, 704, and 706 are rectangular in shape, and include one or more respective events.

Method 400 begins with step 402. In step 402, the timeline display is displayed with a timeline scroll axis and a category axis.

A timeline scroll axis is an axis along which a user may scroll to change the window of a timeline being displayed. For example, in timeline display 700, timeline scroll axis 708 is positioned horizontally across the top of the display. Timeline display 700 provides a window of day, 21 Mar. 2016, from 8:00 to 17:00. A window is the time period within the timeline that may be viewed in the timeline display. A user may scroll back and forth to view different windows of time via timeline scroll axis 708 using any method known to those of skill in the art. For example, a user may select scroll buttons 710, depicted as arrows in FIG. 7.

The timeline display is further includes a category axis. A category axis is an axis of the display along which timeline events may be grouped by category. For example, in timeline display 700 each of first, second, and third dynamically sized display areas 702, 704, and 706 are associated with a different category along the vertically-oriented category axis 712.

Method 400 continues with step 404. In step 404, the first dynamically sized display area in the timeline display is displayed with a first length parallel to the category axis. The first dynamically sized display area is associated with a first category associated with one or more first category events, the first length being proportionate to a first user-directed variable.

A category may include any concept, event, project, or data known to those of skill in the art. The one or more events associated with the category may include planned events or happenings, occasions, reminders, or any other data that can be associated with a specific time on a timeline.

For example, in timeline display 700, first dynamically sized display area 702 is displayed with a first length 714 parallel to the category axis 712. First dynamically sized display area 702 is associated with the category, “Studio renovation.”

A user-directed variable may include any variable that a user may directly or indirectly designate. In one example, the user-directed variable may be a user-selected dynamically sized display area length. A user may, for example using a cursor or via touchpad interface, manually resize one or more dimensions of a dynamically sized display area to generate the user-selected dynamically sized display area length.

In further examples, however, the user-directed variable may be associated with an importance level, an urgency level, or a number of category events, as will be further described below.

For example, in timeline display 700, second dynamically sized display area 704 is displayed with a second length 716 parallel to the category axis 712. Second dynamically sized display area 704 is associated with the category, “Rugby club.”

By selecting a length of a dimension of a dynamically sized display area to be proportionate to a user-directed variable, it may be possible to, for example, decrease or increase the length of the dynamically sized display area based on increases or decreases in the user-directed variable. In examples, the length may be linearly proportional to the user-directed variable. In further examples, however the length may be substantially proportional to the user-directed variable. In further examples, there may be a range over which the length is proportionate to a user-directed variable, such as between a predetermined minimum length or a predetermined maximum length of the dynamically sized display area.

Method 400 continues with step 406. In step 406, the second dynamically sized display area is displayed in the timeline display with a second length parallel to the category axis, the second dynamically sized display area associated with a second category including one or more second category events, the second length being proportionate to a second user-directed variable.

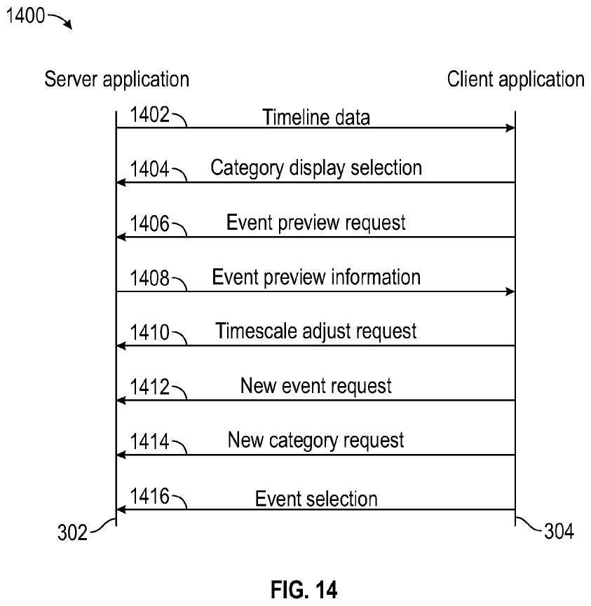

FIG. 14 depicts sequence diagram 1400. Sequence diagram 1400 depicts example implementations of the steps of methods 400, 500, and 600.

In the example of sequence diagram 1400, steps 402, 404, and 406 may be initiated when timeline data 1402 is received at client application 304 from server application 302. In examples, server application 302 may access the information provided in timeline data 1402 by querying interactive timeline database 106.

Timeline data 1402 may include information about the timeline window, categories, and events in timeline display 700. For example, timeline data 1402 may be defined via by the following JSON document:

```
var timeline_data = [
  ″timescale″ :
  { ″timescale_reference_time″ : ″23489″,
  ″timescale_size″ : ″454″ },
  ″categories″ : [
  { ″category_title″ : ″Studio renovation″,
  ″category_length″ : ″2″,
  ″events″ : [
    { ″event_title″ : ″Floor removal″,
    ″event_time″ : ″3543″ },
    { ″event_title″ : ″Painters″,
    ″event_time″ : ″53456″ },
    { ″event_title″ : ″Inspector″,
    ″event_time″ : ″34674″ },
    { ″event_title″ : ″Electricians″,
    ″event_time″ : ″24677″ } ]
  },
  { ″category_title″ : ″Rugby training″,
  ″category_length″ : ″1″,
  ″events″ :
    { ″event_title″ : ″Rugby training″,
    ″event_time″ : ″3849393″ }
  },
  { ″category_title″ : ″Birthday dinner party″,
  ″category_length″ : ″3″,
  ″events″ : [
    { ″event_title″ : ″Buy vegetables and wine
at Waitrose″,
    ″event_title″ : ″Clean house″,
    ″event_time″ : ″77355″ },
    { ″event_title″ : ″Bake sponge cake and
cool″,
    ″event_time″ : ″9932″ },
    { ″event_title″ : ″Thaw out chicken″,
    ″event_time″ : ″335098″ },
    { ″event_title″ : ″Prepare chicken tagine″,
    ″event_time″ : ″109844″ },
    { ″event_title″ : ″Ice the sponge″,
    ″event_time″ : ″209835″ },
    { ″event_title″ : ″Set table″,
    ″event_time″ : ″53225″ } ]
  } ]
```

As may be seen in the timeline_data object, the record timescale includes information regarding the timescale displayed along the timescale axis, as will be further discussed below with regards to steps 516 and 518 below.

The timeline_data object further includes records for each category to be included in the display. The first category record provides for a category_title defined as “Studio renovation.” “Studio renovation” includes three separate events under the record events.

In the example of timeline_data, each category includes a category_length record. The category_length may correspond to the first or second lengths, of the respective first or second dynamically sized display areas. In the example of timeline data 1402 the first and second lengths are provided by server application 302, however this example is not intended to be limiting. In further examples, the first and second lengths may be determined by client application 304 based on a respective first and second user-directed variable, as will be understood by those of skill in the art.

By providing for a first and second dynamically sized display area, each dynamically sized display area associated with a respective category, and including a respective length for each dynamically sized display area proportionate to a respective category-specific user-directed variable, it may be possible to optimize the use of a user's screen space. For example, it may be possible to provide the most display space to those categories that a user determines require the most attention, or to provide the most display space to those categories that are the most important via the user's designation of a respective user-directed variable.

The example of timeline display 700 is not intended to be limiting. Although three dynamically sized display areas are included for illustration, those of skill will readily understand that timeline display 700 may include any number of dynamically sized display areas. In addition, timeline scroll axis may alternatively be positioned vertically, and category axis may be positioned horizontally.

In examples, the first user-directed variable may be a number of first category events and/or the second user-directed variable may be a number of second category events.

The number of category events is the total number of events associated with a category. For example, in FIG. 7, the category, “Studio renovation,” includes four events displayed in the first dynamically sized display area 702, “Floor removal,” “Painters,” “Inspector,” and “Electricians.” The “Studio renovation” category may include further events not displayed on the timeline display, however, because these events each are associated with event times that are not within the timeline window on display, however. The first length of the first dynamically sized display area 702 will reflect those events outside of the timeline window as well.

By providing a first and second user-directed variable that is a number of first and second respective category events, it may be possible to optimize use of screen space for those categories that have the most associated events, and may therefore be relatively more important than categories with fewer associated events.

In further examples, however, the first user-directed variable may be a number of first category displayed events and/or the second user-directed variable may be a number of second category displayed events.

The number of displayed events is the total number of events associated with an event time that is within the timeline window displayed. For example, in FIG. 7, the category, “Studio renovation,” includes four events, so the number of first category displayed events in the example is four. If the “Studio renovation” category includes further events not visible in the timeline window depicted on the timeline display, however, those additional events are not reflected in first category displayed events, and therefore do not affect the first length of the first dynamically sized display area 702.

By providing a first and second user-directed variable that reflects a number of displayed events, it may be possible to optimize use of screen space for those categories that have the most activity during the window of time being displayed.

In examples, the first user-directed variable may be a first user-designated importance level and the second user-directed variable is a second user-designated importance level.

A user-designated importance level is a user-designated metric of the relative importance or priority that a user assigns to a category. In examples, a user-designated importance level may be a priority or rank for a category.

By providing for a user-designated importance level that is proportionate to a length of a dynamically sized display area, it may be possible to optimize use of screen space for those categories that a user determines are most important. This may provide a display that reflects those categories that are the most important to the user.

The examples provided for possible user-directed variables of a number of category events, a number of category displayed events, and a user-designated importance level are not intended to be limiting. In further examples, a user-directed variable may include any further designation or criteria that may be directly or indirectly set by a user.

In examples, method 400 may include further steps. For example, method 400 may include step 408. In step 408, a category display selection user interface may be displayed.

A category display selection user interface may allow a user to chose which categories, and therefore which respective dynamically sized display areas, may be displayed in a timeline interface.

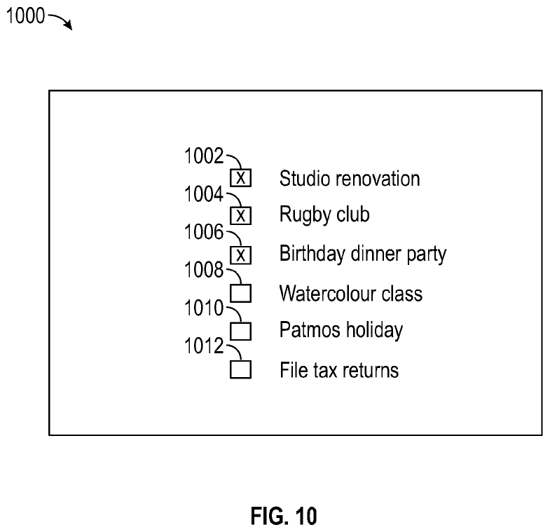

For example, FIG. 10 depicts example category display selection user interface 1000. Category display selection user interface 1000 includes six category display selections, 1002, 1004, 1006, 1008, 1010, and 1012. In the example, the category display selections, “Studio renovation,” “Rugby club,” and, “Birthday dinner party,” are selected for display.

In examples, method 400 may further include step 410. In step 410, a category display selection may be received. The category display selection may include a first category and a second category. In further examples, such as the example of FIG. 10, category display selections identifying further categories may be provided.

In examples, client application 304 may transmit the category selections to server application 302. For example, sequence diagram 1400 depicts client application 304 transmitting category display selection 1404 to server application 302. In examples, server application 302 may modify and transmit updated timeline data 1402 to the client application 304 based on category display selection 1404.

In examples, each respective first category event of the one or more first category events and each respective second category event of the one or more second category events may be associated with a respective data item.

In examples, at least one of the first category or the second category may be associated with a respective data item.

In examples, each respective data item may be associated with at least one of: text, photo, video, audio, a document, a website, or a link.

For example, the event titled, “Bake sponge cake and cool” in third dynamically sized display area 706 depicted in FIG. 7 may be associated with a recipe. The recipe may include text and a photo, a video, or a URL reference to a recipe online.

In a further example, the second category represented in second dynamically sized display area 704 of FIG. 7 may be associated with a URL for a rugby club, a photo of the rugby club, or a video of a rugby match.

By associating a category, and/or an event with a data item, it may be possible to provide a dynamic timeline display that includes information from many areas of a user's life. Instead of providing excessive information that would otherwise be difficult for the user to digest, especially on a smaller screen, the dynamic nature of the dynamically sized display areas may therefore help the user determine what is important in a timeline window display.

In examples, at least one of the first category or the second category may further include one or more attributes, including at least one of: a tag, a to do, a comment, a geographical location, a submitter, a creation time, a creation date, a rating, a number of views, an associated data entry, changes to the data entry, file size, a link, a topic of conversation, a price, an associated group, a price, a file, a permissions parameter, or a vote parameter. Other category attributes are also possible, as will be understood by those of skill.

In examples, at least one of a first category event or a second category event may further include one or more attributes, including at least one of: a tag, a to do, a comment, a geographical location, a submitter, a creation time, a creation date, a rating, a number of views, an associated data entry, changes to the data entry, file size, a link, a topic of conversation, a price, an associated group, a price, a file, a permissions parameter, or a vote parameter. Other event attributes are also possible, as will be understood by those of skill.

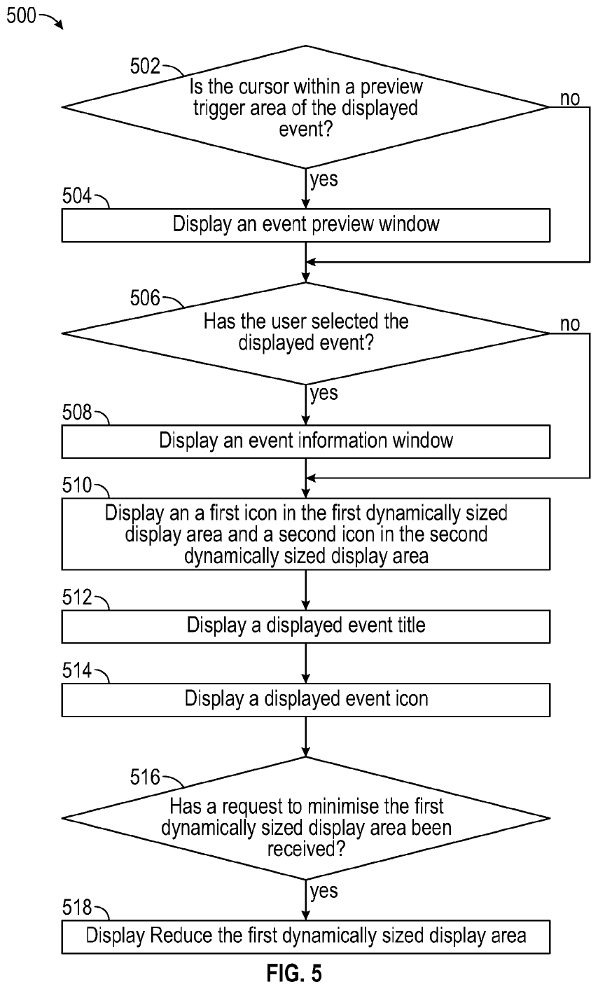

In examples, method 400 may further include any of the steps of method 500 depicted in FIG. 5. For example, method 400 may include steps 502, and 504. In 502, it may be determined that the cursor is within a preview trigger area of the displayed event in the timeline display.

A preview trigger area may include the area immediately adjacent to a displayed event in the timeline display. For example, in FIG. 7 preview trigger area 718 is represented by a dotted line surrounding the displayed event, “Rugby training.”

As may be seen in example sequence diagram 1400, client application 304 may send an event preview request 1406 to server application 302 upon determining that the cursor is within a preview trigger area of a displayed event. For example, event preview request data 1406 may be defined via by the following JSON document:

```
var preview_request_data =
  { ″event_title″ : ″Rugby club″,
  ″event_title″ : ″Rugby training″ }
```

In step 504, an event preview window may be displayed upon determining that the cursor is within the preview trigger area.

As may further be seen in example sequence diagram 1400, server application 302 may, after querying information from interactive timeline database 106, transmit the data requested by client application 304, event preview information 1408. Event preview information 1408 may include information or data items associated with the requested event, category.

An event preview window may provide a small popup screen displaying information about the event. In examples, the event preview window may display information about a data item associated with the event.

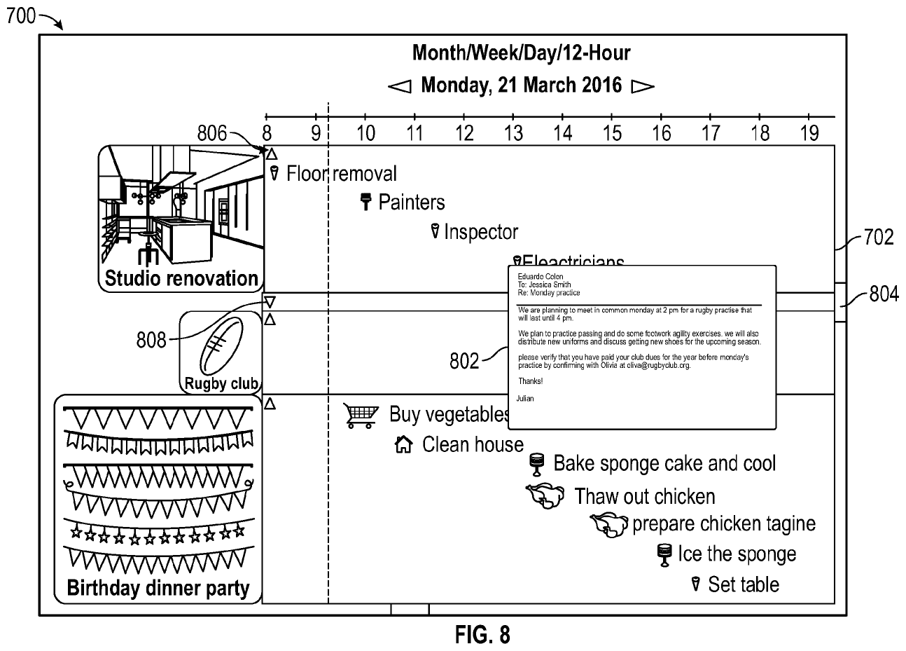

For example, FIG. 8 depicts timeline display 700 with event preview window 802, which is associated with preview trigger area 718 for the event, “Rugby training.”

In examples, method 400 may further include steps 506 and 508. In step 506, it may be determined whether a user has selected the displayed event. In step 508, an event information window may be displayed upon determining that the user has selected the displayed event.

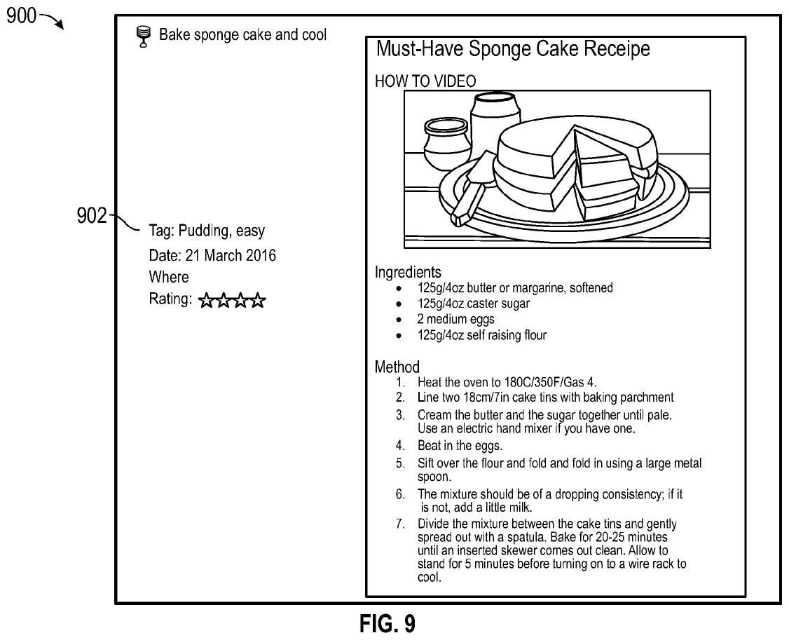

FIG. 9 depicts event information window 900. Example event information window 900 is associated with the “Bake sponge and cool” event. Because “Bake sponge and cool” is associated with a data item that includes a recipe, event information window 900 displays the recipe.

In examples, event information window 900 may further display event attributes. For example, FIG. 9 depicts the values for attributes 902, which include: “Tag,” “Date,” “Where,” and “Rating.”

In examples, method 400 may further include step 510. In step 510, a first icon may be displayed in the first dynamically sized display area and a second icon in the second dynamically sized display area.

For example, in FIG. 7 first dynamically sized display area 702 includes first icon 720, a sketch of a studio renovation, and second dynamically sized display area 704 includes second icon 722, a logo for a rugby club. Each of first icon 720 and second icon 722 may provide a representation or an association of the respective underlying category for the user.

In examples, a first icon length may be proportionate to the first length and a second icon length may be proportionate to the second length.

For example, it may be seen in FIG. 7 that first icon 720 has the same height as first height 714 of first dynamically sized display area 702, and second icon 722 has the same height as second height 716 of second dynamically sized display area 704.

In examples, an icon length may be cropped or stretched within a dynamically sized display area.

Much like first and second height 714 and 716 of first and second dynamically sized display areas 702 and 704, the size of first and second icon lengths 720 and 722 may therefore provide a quick visual signal to the user about what information is important on a screen. This may further dedicate screen space to important information for the user.

In examples, a displayed event title may be displayed in the timeline display. For example, event 724 is displayed with an event title, “Painters.”

In examples, a displayed event icon may be displayed in the timeline display. For example, event 724 is displayed with a displayed event icon 726, a paint brush.

By displaying events with event icons, it may be possible to quickly convey important information to a user while optimizing the use of screen space.

In examples, the first category may be associated with a first data item including text, and the first icon may include at least a subset of miniaturized text from the first data item.

For example, FIG. 8 depicts event preview window 802. Event preview window 802 includes a data item associated with the event, “Rugby training,” an email. Event preview window 802 provides a miniaturized version of the email. Providing a miniaturized version of the text from the data item, the email, may help the user preview, or recall the contents of the data item while optimizing the use of screen space.

In examples, the timeline display may include a second scrollable axis along the category axis. The second scrollable axis may allow a user to scroll along the category axis of the timeline display.

For example, FIG. 8 depicts second scrollable axis 804. In the example of timeline display 700, scrollable axis 804 may be used to scroll along the vertical axis to view different dynamically sized display areas.

In examples, method 400 may further include steps 516 and 518. In step 516, it may be determined that a request to minimize the first dynamically sized display area has been received. In step 518, the first dynamically sized display area may be reduced upon determining that the request was received.

For example, it may be seen in FIG. 8 that each dynamically sized display area of timeline display 700 may include a minimize button 806, represented by an arrow tip facing up in the upper left corner of each respective dynamically sized display area. By selecting the minimize button, for example minimize button 806, a user may initiate a request to minimize a dynamically sized display area, for example first dynamically sized display area 702.

In examples, once minimized a category may be hidden and represented by a maximize button. For example, it may be further seen in FIG. 8 that timeline display 700 includes a maximize button 808 represented by an arrow tip facing down in the corner of a minimized dynamically sized display area. Upon selecting the maximize button, a user may initiate a request to maximize a dynamically sized display area.

The examples of minimize and maximize buttons are not intended to be limiting. Other methods are possible to allow a user to request to minimize or maximize display areas, such as providing a dedicated user interface, as will be understood by those of skill.

In examples, the timeline display may further include a timescale adjustment for the timeline scrollable axis.

The timescale adjustment may, for example, include changing the total amount of time displayed along the scrollable timescale axis 708. For example, a user may adjust the timeline window size displayed from 12-hours to a day, a week, or a month using the timescale size buttons 730 depicted in FIG. 7.

In further examples, however, the timescale adjustment may include changing a timescale reference time along the scrollable timescale axis. For example, if the reference time is the initial time displayed in timeline display, 21 Mar., 2016 at 8 am in the example of timeline display 700, it may be possible to adjust the reference time to look at a different 12-hour window of time. In examples, the timescale adjustment to the reference time may be performed using timeline scroll axis 708, or scroll buttons 710.

In further examples, however, the timescale adjustment may be made via a cursor or a touchpad interface. For example, a pinch or expand gesture using two fingers and a touchpad interface may expand or contract the total amount of time displayed. A single finger swipe may change the timescale reference time.

In further examples, the timescale adjustment may be performed by selecting a timeline start time and a timeline end time. For example, a user may enter the timeline start and end times into a text entry box.

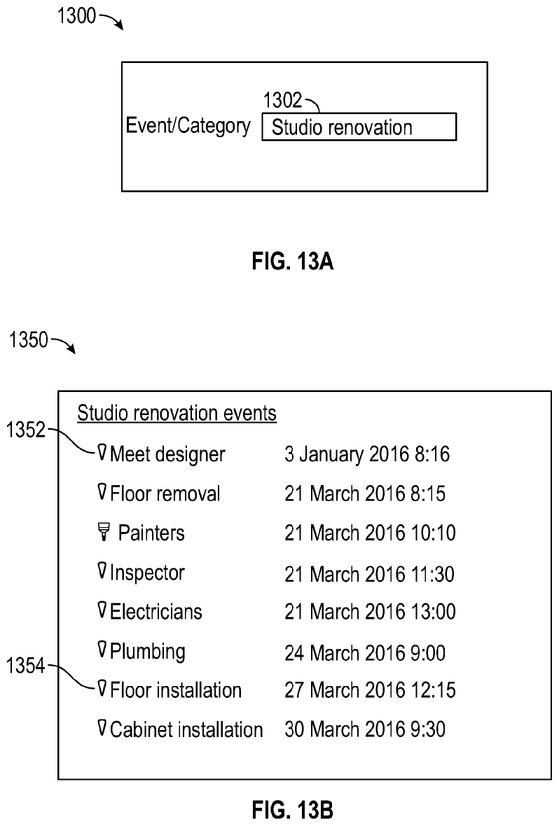

For example, FIG. 13 depicts client 304 transmitting timescale adjust request 1410 to server 302. In examples, timescale adjust request 1410 may be defined via by the following JSON document:

```
var timescale_adjust_request = {
  ″timescale″ :
  { ″timescale_reference_time″ : ″903485098″,
  ″timescale_size″ : ″Day″ }
```

In examples, updates to timeline data 1402 transmitted from server application 302 to client application 304 may reflect the new timescale after the timescale adjust request 1410 is received.

By providing a timescale adjustment, this may allow a user to view different timeline windows to optimize use of screen space. For example, during a time period when there are few events, a larger timeline window optimize the user of screen space. During a time period when there are many events, however, a smaller timeline may make better use of screen space, allowing the user to avoid the need to perform excessive scrolling.

In examples, at least a first event of the one or more first category events may be displayed in a first colour for a first urgency value, and at least a second event of the one or more first category events may be displayed in a second colour for a second urgency value.

An urgency value is much like an importance value for categories, but for events.

In examples, at least a first event of the one or more first category events may be displayed at a first blink rate for a first urgency value, and at least a second event of the one or more first category events may be displayed in a second blink rate for a second urgency value.

In examples, at least a first event of the one or more first category events may be displayed with a first icon for a first urgency value, and at least a second event of the one or more first category events may be displayed with a second icon for a second urgency value.

By displaying events with signals indicating urgency, using different colours, different blink rates, or different event icons, this may provide an additional clue about what is relevant to a user on a timeline beyond the clue provided by the size of a dynamically sized display area.

In examples, method 400 may further include any of the steps of method 600. For example, method 400 may include steps 602, 604, and 606. In step 602, a new event creation user interface may be displayed.

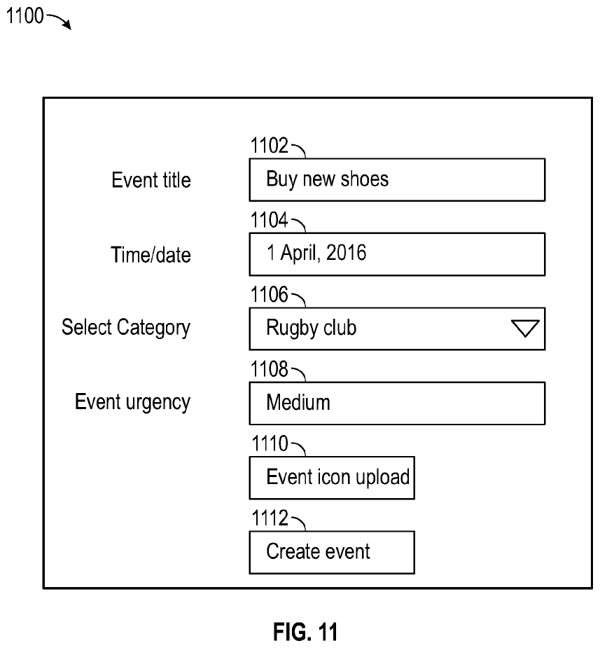

For example, FIG. 11 depicts example new event creation user interface 1100. New event creation user interface 1100 may include an event title field 1102, a time/date field 1104, a category field 1106, an event urgency field 1108, and an event icon upload button 1110.

In step 604, a new event may be received from the new event creation user interface. For example, the new event may be received after a user selects the create event button 1112 positioned on new event creation user interface 1100.

In step 606, the new event may be sent to a server.

For example, sequence diagram 1400 depicts client application 304 transmitting new event request 1412 to sever application 302. In examples, new event request 1412 may be defined via by the following JSON document:

```
var new_event_request = {
  ″event_title″ : ″Floor removal″,
  ″event_time″ : ″23489″,
  ″category_title″ : ″Rugby club″ ,
  ″event_urgency″ : ″Medium″ ,
  ″event_icon_ref″ : http://bit.ly/2fLYjqm }
```

Upon receiving new event request 1412, server application 302 may store the new event in interactive timeline database 106. Subsequent timeline data 1402 sent from server application 302 to client application 304 may include the new event.

In examples, method 400 may further include steps 608, 610, and 612. In step 608, a new category creation user interface may be displayed.

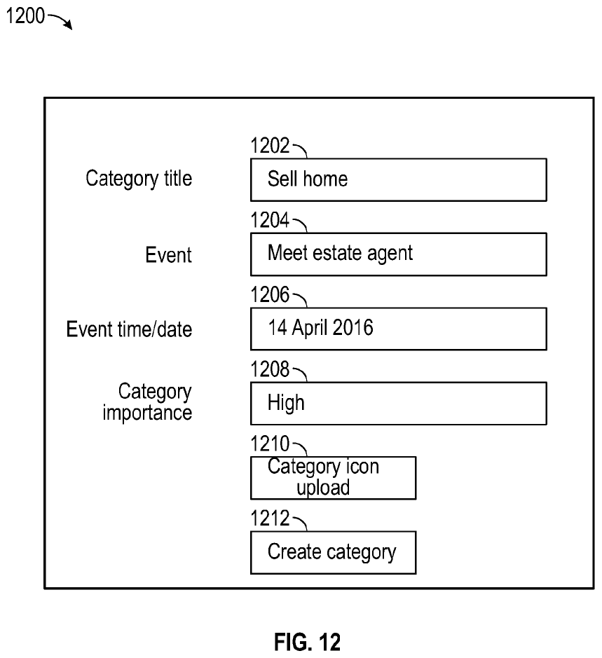

For example, FIG. 12 depicts new category creation user interface 1200. New category creation user interface 1200 may include category title field 1202, an event field 1204, an event time/date field 1206, a category importance field 1208, and a category icon upload button 1210.

In step 610, a new category may be received from the new category creation user interface. For example, the new category may be received after a user selects the create category button 1212 positioned on new category creation user interface 1200.

In step 612, the new category may be sent to a server.

For example, sequence diagram 1400 depicts client application 304 transmitting new category request 1414 to sever application 302. In examples, new category request 1414 may be defined via by the following JSON document:

```
var new_category_reguest = {
  ″category_title″ : ″Sell home″,
  ″event_title″ : ″Meet estate agent″ ,
  ″event_time″ : ″23343489″ ,
  ″event_urgency″ : ″High″ ,
  ″event_icon_ref″ : http://bit.ly/233idYjqm }
```

Upon receiving new category request 1414, server application 302 may store the new category, and if included related event, to interactive timeline database 106. Subsequent timeline data 1402 sent from server application 302 to client application 304 may include the new category and/or event.

By allowing a user to define categories and related events, which are displayed in dynamically sized display areas associated with categories, it may be possible to optimize the use of screen space for those events that are most relevant or important to a user. The user may therefore avoid searching for relevant information. The user of further visual clues may further provide additional indicators that help the user quickly determine what events on a timeline are a priority.

15

In examples, method 400 may further include steps 614, 616, and 618. In step 614, a search user interface may be displayed. In step 614, a search user interface may be provided.

For example, FIG. 13A depicts an example search user interface 1300. Search user interface 1300 may include event/category search field 1302. By entering an event or a category into search field 1302, a user may search for all of the locations in the timeline where a searched event or events associated with a searched category appear.

FIG. 13B depicts search results user interface 1350. Search results user interface 1350 provides events associated with a requested event or category, which in the example is the category, “Studio renovation.” In examples, the events may be displayed in chronological order, vertically or horizontally. As may be seen in FIG. 13B, some of the events associated with “Studio renovation,” for example events 1352 and 1354, are associated with times that are before or after the timeline window displayed in timeline display 700 on 21 Mar. 2016.

Method 600 may continue with step 616. In step 616, an event selection may be received. For example, a user may select an event from search results user interface 1350. As depicted in sequence diagram 1400, event selection 1416 may be received at server application 302 from client application 304. Server application 302 may respond by providing updated timeline data 1402 to client application 304.

In step 618, an updated timeline display may be provided. The updated timeline display may depict a different timeline window based on the event selection provided. For example, if event selection 1416 includes event 1354, the timeline window in the updated timeline display may be centred on 27 Mar. 2016 at 12:15.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for providing a timeline display with a first dynamically sized display area and a second dynamically sized display area, the method comprising:
providing for displaying the timeline display with a timeline scroll axis and a category axis;
providing for displaying the first dynamically sized display area in the timeline display with a first length parallel to the category axis, the first dynamically sized display area associated with a first category associated with one or more first category events, the first length being proportionate to a first user-directed variable; and
providing for displaying the second dynamically sized display area in the timeline display with a second length parallel to the category axis, the second dynamically sized display area associated with a second category including one or more second category events, the second length being proportionate to a second user-directed variable.

2. A method according to claim 1, wherein the first user-directed variable is a number of first category events and the second user-directed variable is a number of second category events.

3. A method according to claim 1, wherein the first user-directed variable is a number of first category displayed events and the second user-directed variable is a number of second category displayed events.

4. A method according to claim 1, wherein the first user-directed variable is a first user-designated importance level and the second user-directed variable is a second user-designated importance level.

5. A method according to claim 1, further comprising:
providing for displaying a category display selection user interface.

6. A method according to claim 5, further comprising:
providing for transmitting a category display selection to a server.

7. A method according to claim 1, wherein each respective first category event of the one or more first category events and each respective second category event of the one or more second category events is associated with a respective data item.

8. A method according to claim 1, wherein at least one of the first category or the second category is associated with a respective data item.

9. A method according to claim 1, wherein each respective data item is associated with at least one of: text, photo, video, audio, a document, a web site, or a link.

10. A method according to claim 1, wherein at least one of the first category or the second category further includes at least one of: a tag, a to do, a comment, a geographical location, a submitter, a creation time, a creation date, a rating, a number of views, an associated data entry, changes to the data entry, file size, a link, a topic of conversation, a price, an associated group, a price, a file, a permissions parameter, or a vote parameter.

11. A method according to claim 1, wherein at least one of a first category event or a second category event further includes at least one of: a tag, a to do, a comment, a geographical location, a submitter, a creation time, a creation date, a rating, a number of views, an associated data entry, changes to the data entry, file size, a link, a topic of conversation, a price, an associated group, a price, a file, a permissions parameter, or a vote parameter.

12. A method according to claim 1, further comprising:
providing for displaying an event preview window upon determining that a cursor is within a preview trigger area of the displayed event in the timeline display.

13. A method according to claim 1, further comprising:
providing for displaying an event information window upon determining that a user has selected the displayed event.

14. A method according to claim 1, further comprising:
providing for displaying a first icon in the first dynamically sized display area and a second icon in the second dynamically sized display area.

15. A method according to claim 1, wherein a first icon length is proportionate to the first length and a second icon length is proportionate to the second length.

16. A method according to claim 1, further comprising:
providing for displaying a displayed event title in the timeline display.

17. A method according to claim 1, further comprising:
providing for displaying a displayed event icon in the timeline display.

18. A method according to claim 1, wherein the first category is associated with a first data item including text, and the first icon includes at least a subset of miniaturized text from the first data item.

19. A method according to claim 1, wherein the timeline display includes a second scrollable axis along the category axis.

20. A method according to claim 1, further comprising:
upon receiving a request to minimize the first dynamically sized display area, providing for reducing the first dynamically sized display area.

21. A method according to claim 1, wherein the timeline display further includes a timescale adjustment for the timeline scrollable axis.

22. A method according to claim 1, wherein the at least a first event of the one or more first category events is displayed in a first colour for a first urgency value, and at least a second event of the one or more first category events is displayed in a second colour for a second urgency value.

23. A method according to claim 1, wherein the at least a first event of the one or more first category events is displayed at a first blink rate for a first urgency value, and at least a second event of the one or more first category events is displayed in a second blink rate for a second urgency value.

24. A method according to claim 1, wherein the at least a first event of the one or more first category events is displayed with a first icon for a first urgency value, and at least a second event of the one or more first category events is displayed with a second icon for a second urgency value.

25. (canceled)

26. (canceled)

27. (canceled)

28. A system configured to provide an interactive timeline display via the method of claim 1.

29. (canceled)

30. An electronically readable medium configured for storing a computer program configured to provide an interactive timeline display via the method of claim 1.

31. (canceled)
